(19) United States
(12) Patent Application Publication
(10) Pub. No.: US 2005/0210025 A1
(43) Pub. Date: Sep. 22, 2005

(54) System and method for predicting the ranking of items

(76) Inventors: Michael Edward Dalton, Canberra (AU); Allan Edward Dalton, Canberra (AU)

Correspondence Address: VIKTORIA GAW, 2561 VERBENA DRIVE, HOLLYWOOD, CA, 90068, US

(21) Appl. No.: 11/070,881

(22) Filed: Mar. 3, 2005

(30) Foreign Application Priority Data
Mar. 17, 2004 (AU) 2004901375

(51) Int. Cl. G06F 7/00

(52) U.S. Cl. 707/5

(57) ABSTRACT

An interactive method of responding to a request to predict how a user would rank items which may be unfamiliar to that user. The invention uses reports provided by a plurality of users containing the order in which the users ranked a selection from a list of items. Items are selected from one or more of the categories of products, services, performers, competitors, events and the like. The process involves the creation of a group of users where the group can include some users who have not necessarily ranked any of the same items as the requestor.

### FIELD OF INVENTION

This invention relates to a method and system of ranking preferences and personalising the results of searches.

The invention is suited to ranking a wide range of products and services. More particularly, the invention relates to extending user-based collaborative filtering techniques to large and sparse datasets where a user's immediate neighbourhood may be empty.

### BACKGROUND OF INVENTION

There is an ever-widening choice for a broad of range of products and services: entertainment such as movies; books; holidays; restaurants; people providing specialist trades; consultants; consumer products. To assist people in their decision making, collaborative filtering techniques have been developed. Where data are available, the most accurate techniques are generally considered to be user-based systems where users provide information on what items they like or don't like. This information is analysed to determine which users have similar preferences. These users are grouped together into a ‘neighbourhood’.

The techniques for user-based collaborative filtering are described in a number of patents. For example, U.S. Pat. No. 5,583,763 (Atcheson et al) describes a method whereby users prepare a list of preferred items in a particular category. The list of the ‘subject’ user is compared to the lists of the other users to identify users who have the same as well as other items in their lists. Users with the same items in their preference sets are included in the ‘subject’ user's similarity neighbourhood. The different items included in the similarity neighbourhood group are used to predict what items the ‘subject’ will prefer. Subsequent patents have proposed modifications to this neighbourhood concept. Nevertheless, the principle of close neighbourhood similarity is retained in subsequent patents, that is, all users in a neighbourhood group have some overlap in their preference sets with the ‘subject’ user's preference set.

A second common element among many patents is the use of cardinal values to analyse the preference sets of users. For example, U.S. Pat. No. 6,249,785 (Paepke) requires users to associate a numerical weight with their preferences. Other systems assign a weight of one to an included item and zero to an excluded item. The use of cardinal values facilitates the process of comparing and aggregating the preference sets of multiple users.

Significant problems arise in the use of these user-based collaborative filtering systems when the datasets are large and sparse. In other words, when there are potentially many items that could be compared, users may only have sampled a small number of those items and there could be little overlap in the preference sets of users.

For example, in Australia, Perth is a city of 1.3 million people and Canberra has a population of 0.3 million. These cities are nearly 4,000 km apart. A person moving from Perth to Canberra may have difficulty finding someone in Canberra who has both experience of using the same plumber as they did in Perth and a good knowledge of a variety of plumbers in Canberra. Thus creating a neighbourhood group with overlapping experience of plumbers in Canberra and Perth could be difficult.

A number of systems have been proposed to overcome the problem of neighbourhood groups that contain few or no users. For some categories, such as books, a content-based approach may be adopted. In other words, a large number of people who bought one particular book also bought another particular book. Examples of patents include U.S. Pat. No. 6,112,186 (Bergh et al.) and U.S. Pat. No. 6,092,049 (Chislenko et al.). The accuracy of these approaches in terms of producing personalised prediction, however, is generally lower than results achieved when user-based collaborative filtering is possible. Furthermore, the content-based approach is more feasible for product categories where users are likely to have experience of multiple items in the category than service categories where users may be less willing or able to sample a wide variety of items in the category eg plumbers in different parts of the country.

Another potential way of overcoming the neighbourhood group problem is to use indirect association. Continuing the plumber example, another city in Australia is Sydney with a population of 4.3 million and approximately 300 km from Canberra. There would be a greater number of people who have moved from Perth to Sydney and more people who have the dual experience of Sydney and Canberra plumbers. A link could be established between plumbers in Perth and Canberra through plumbers in Sydney. However, the level of statistical significance (and hence accuracy) declines significantly when such indirect associations, or intermediaries, are involved. For example, the correlation between people knowledgeable about plumbers in Perth and Sydney plumbers could 0.7 and the correlation between plumbers in Sydney and Canberra could be 0.8. The resultant correlation between Perth and Canberra is unlikely to be higher than the product of these two correlations, that is, 0.56. This correlation may be too small to make statistically meaningful comparisons. The problem is compounded when the indirect association involves two or more intermediaries eg in the plumber example, another city such as Adelaide which is closer to Perth than either Sydney or Canberra and has a population of about 1 million may be needed to make the plumber connection between Perth and Canberra, that is, Perth-Adelaide-Sydney-Canberra.

Sometimes, indirect associations are identified through analysis of information on socio-economic and demographic characteristics eg people in the same socio-economic group are assumed to have similar tastes. However, the accuracy of this approach differs among the various products and services and cannot be relied on to overcome all potential problems associated with large, sparse datasets.

The low level of correlation and/or accuracy as a result of using indirect associations to make predictions when the datasets are large and sparse is a major reason why this indirect approach to resolving problems of neighbourhoods with no members has not been applied widely. This invention involves a modification of the indirect association approach to generate more accurate results.

The main reason why the approach set out in this invention has not previously been put forward to overcome the problem of large, sparse datasets is because collaborative filtering systems have been designed to utilise cardinal values rather than ordinal values.

Cardinal values are one, two, three, etc. Their use requires some judgement of absolute value, that is, item A may be rated 9 stars and is considered very similar to item B which is rated 8 stars but both items are much better than item C which is rated 2 stars. Ordinal values, on the other hand, are first, second third. Their use only implies judgement of relative value. Using the above example, item A is ranked ahead of item B which is ranked ahead of item C. From the following discussion, it will become evident why the additional information contained in cardinal values can compound the problem of aggregating the preferences of users.

There are good reasons why the use of ordinal values would not have been seriously considered as a means of overcoming the problem of large, sparse datasets.

Most people believe, without further investigation, that ordinal values cannot be aggregated across different users. For example, two ‘third’ positions in separate lists do not necessarily lead to an item being ranked ‘third’ in an aggregate list. Social choice theory is a major academic discipline that has discussed this issue extensively.

Social choice theory has a tradition going back more than 200 years. The Condorcet approach to selecting the preferred choice out of an ordinal list of options might be broadly defined as a pair wise majority approach, that is, the option that is placed first most often. The Borda approach is broadly based on assigning values to all the possible items/options being ranked, that is, assigning cardinal weights, and then adding up the cardinal values to find the most preferred item.

Shortly after World War II and in reference to voting systems, K. Arrow proved that it was impossible to design a set of rules for social decision making that would obey every ‘reasonable’ criterion required by society. According to Wikipedia (http://en.wikipedia.org/wiki/Arrow's impossibility theorem): “The theorem's content, somewhat simplified, is as follows. A society needs to agree on a preference order among several different options. Each individual in the society has a particular personal preference order. The problem is to find a general mechanism . . . which transforms the set of preference orders, one for each individual, into a global societal preference order. This social choice function should have several desirable (“fair”) properties:
unrestricted domain or universality . . . ;
non-imposition or citizen sovereignty . . . ;
non-dictatorship . . . ;
positive association of social and individual values
. . . ;
independence of irrelevant alternatives . . . .

Arrow's theorem says that if the decision-making body has at least two members and at least three options to decide among, then it is impossible to design a social choice function that satisfies all these conditions at once.”

This theorem would appear to rule out the possibility of uncontroversial aggregation of users' ordinal preference sets.

In addition to being aware of the ordinal aggregation problems identified in social choice theory, practitioners of user-based collaborative filtering techniques are likely to be familiar with the theory of consumer preferences, a major component of basic microeconomic theory. Students of economics will be aware that while basic microeconomic theory is framed in terms of ordinal utility, in practice some degree of cardinality (at least the assumption that aggregation across consumers is possible) must be adopted to draw meaningful policy conclusions. Economics students are also taught that it is not possible to add ordinal utility functions across consumers because consumer satisfaction is subjective not objective. See for example the essay by B. J. Rafferty on The Validity of Marshallian Consumers' Surplus (website reference—econserv2.bess.tcd.ie/SER/archive/2004/3.pdf).

Some researchers have tried to aggregate ordinal rankings by using complex algorithms for a slightly different problem to that of large, sparse datasets. For example a paper by Cynthia Dwork, Ravi Kumar, Moni Naor and D. Sivakumar on Rank Aggregation Methods for the Web (presented at WWW10, May 2-5, 2001, Hong Kong) looks at aggregating the results of the top search results presented by different search engines for the same search words into one consolidated list. The challenge is to minimise the disagreements between the rankings of the different search engines. This challenge involves problems comparable to those identified above in social choice theory. In addition to needing to resolve the problem of defining a ‘good’ consensus, the researchers also concluded that aggregating ordinal ranks is computationally NP-hard (Non-deterministic, Polynomial-time hard), even when the number of rankings to be aggregated is only 4, that is, the results of 4 search engines.

Based on the conclusions of Dwork et al, practitioners in the art of collaborative filtering are likely to conclude that aggregating ordinal rankings for datasets containing hundreds if not thousands of items across thousands of users is computationally not possible at this time. However, the choice of the objective function used in Dwork's computations is one explanation for the conclusion on computational capacity. This invention uses a different objective function which substantially simplifies the computation task.

In summary, there is currently no general solution to the problem of making accurate predictions with regard to personal preferences when the datasets are large and sparse. Furthermore, there is a mindset that generally prevents researchers thinking about the use of ordinal values in personal preference sets to resolve the problem.

This invention avoids these problems and difficulties by using ordinal values in preference sets and grouping users with very similar sets of ordinal preferences. Arrow's Impossibility Theorem is only relevant when there are at least three choices. Users can be allocated into groups when the preference sets of all users in a group are perfectly correlated with the consolidated preference set of that group, that is, there are less than three options. Arrow's Impossibility Theorem does not apply when the users in the group are unanimous in their preference rankings. In such circumstances, there is a well defined consolidated ordinal preference function. The mathematical task is to create such groups by identifying and filling in the gaps in individual users' ordinal functions. For example, User 1 has an ordinal preference set consisting (in rank order) items A, D, G. User 2 has a preference set of items B, E, H. User 3 has a preference set of items C, F, I. User 4 has a preference set of items A, C, E. In this simple example, a consistent consolidated preference function for all users would be A, B, C, D, E, F, G, H, I. When these users' preferences were expressed in terms of cardinal values, User 2 gave a rating of 10 to item B, a rating of 9 to item E and a rating of 1 to item H. User 4 gave a rating of 10 to item A, a rating of 2 to item C and a rating of 1 to item E. The cardinal ratings for item E would suggest non-comparability across Users 2 and 4 even though the consolidated ordinal ranking is comparable over all users. Thus the full preference sets of User 2 and User 4 would not be included in the same neighbourhood group under current user-based collaborative filtering techniques. In practical terms in this invention, items would only be included in a consolidated preference set provided several users (at least three) had ranked each item.

The mathematical task associated with this invention is analogous to solving a jigsaw puzzle. Not all jigsaw pieces connect to each other but there must be overlapping edges in individual pieces to create the overall picture. In terms of the problem of large and sparse datasets, the pieces of several different jigsaw puzzles are all mixed together. The task of the computer is not only to sort out which pieces belong to which puzzle but also how the pieces of each puzzle fit together.

This invention creates a qualitative ‘measuring stick’ to use in comparing users' preferences. This measuring stick enables the process of grouping users with similar preferences to be automated. Grouping is not based on characteristics such as age and education but is determined through recognition of common patterns in user preferences. The number of groups is automatically determined. Cardinal based systems can rely on the skills and experience of human analysts to identify relevant patterns. Automated analysis is a useful characteristic when large volumes of information need to be collected and analysed quickly.

This invention does not claim to be more accurate when the datasets of user preferences contain large overlaps between users. The use of the qualitative ‘measuring stick’, however, means the number of users in a group drawn from a large sparse dataset is likely to be larger than the number of users in the equivalent neighbourhood groups created through existing user-based collaborative filtering techniques. Thus this invention enables accurate predictions to be made for a wider range of products and services, that is, those products and services which have empty or nearly empty neighbourhood datasets.

### SUMMARY OF INVENTION

According to a first aspect of the invention, an interactive method of creating a consolidated ranking in response to a request for a prediction from a requester where the consolidated ranking predicts how the requestor would rank items, which may be unfamiliar to the requester, using reports that have been provided by a plurality of users containing the order that items are ranked, said items selected from one or more of the categories of products, services, performers, competitors, events and the like; where the method includes the sequential steps of:
(a) presenting to said users a list containing three or more items, said users may include said requester;
(b) obtaining from said users, reports ranking three or more of the items presented in step (a);
(c) creating groups of said users by choosing some of the users to be lead users; calculating correlation between the order that items are ranked in the report of a lead user and the order that the same items are ranked in the report of another user when the reports of both users contain at least three of the same items; and grouping together all users whose reports have calculated correlation with the lead user in excess of a predefined value;
(d) creating separately for each group formed in step (c), a consolidated ranking of all items included in the reports of at least three users in the group by an iterative process that orders items on the basis of the number of times that users in the group rank an item higher than another item when the number of times such assessment is made is weighted by the sum of weights assigned to the two items where those weights were calculated in the previous iteration and where the items' weights for the first iteration are predetermined;
(e) calculating correlation between the order in which items are ranked in each user's report and the consolidated ranking of every group derived in step (d) and then assigning said user to the group with which the said user is most highly correlated;
(f) repeating step (d) using the new groups formed in step (e);
(g) repeating steps (e) and (f) until there is no change in the membership of any group and no change in the list of items in each group's consolidated ranking;
wherein by this process a consolidated ranking for a group, containing predictions based on a request, can be created even though the items in the report of the requestor may not overlap with any of the items in the reports of some of the other said users in the same group.

According to a second aspect of the invention, a system for creating a consolidated ranking which predicts how a user would rank items as a result of creating a group containing the reports of a plurality of users even when the items in the report of the user who has requested the prediction may not overlap with any of the items in the reports of some of the other said users in the group; wherein the system includes:
(a) a display arranged to present to said users a list containing three or more items;
(b) a data entry component arranged to obtain from said users reports ranking three or more of the items presented in step 1(a);
(c) a mechanism arranged to compare the correlation of the said user' reports;
(d) a mechanism arranged to compare the number of items in a said user's report with a predefined number;
(e) a mechanism arranged to compare the number of said users including an item in his/her report with a predefined number; and
(f) a mechanism arranged to present to a said user a consolidated ranking.

According to a third aspect of the invention, a data processing system readable medium having code embodied therein, the code including instructions executable by a data processing system for performing the steps of the first aspect of the invention.

### BRIEF DESCRIPTION OF THE FIGURES

Preferred forms of the method and system of ranking preferences will now be described with reference to the accompanying figures in which:

FIG. 1 shows a block diagram of a system in which one form of the invention may be implemented;

FIG. 2 shows the preferred system of architecture of hardware on which the present invention may be implemented;

FIG. 3 shows the system of entering data in accordance with the invention;

FIG. 4 shows a flowchart of one form of the invention describing the preferred method of creating groups of users;

FIG. 5 shows an example of storing user preferences;

FIG. 6 shows an example of a User Preference Matrix after one user's preferences have been entered;

FIG. 7 shows an example of an Item Preference Matrix after the first iteration and as if only the preferences of one user had been entered;

FIG. 8 shows a flowchart of one form of the invention describing the preferred method of calculating a consolidated preference set, or quord.

FIG. 9 shows the preferred form of presenting the consolidated preference set for all users;

FIG. 10 shows the login screen for a user who is already registered;

FIG. 11 shows the interactive screen for requesting a search;

FIG. 12 shows the interactive screen for adding items to or changing the order of items in the user's existing preference set;

FIG. 13 shows a flowchart of one form of the invention describing the preferred method of responding to a request for valuing/ranking a specific item;

FIG. 14 shows the preferred form of presenting the personal predictions;

FIG. 15 shows the flowchart of one form of the invention describing a method of ranking teams and individuals across categories and over time.

### DETAILED DESCRIPTION OF PREFERRED FORMS

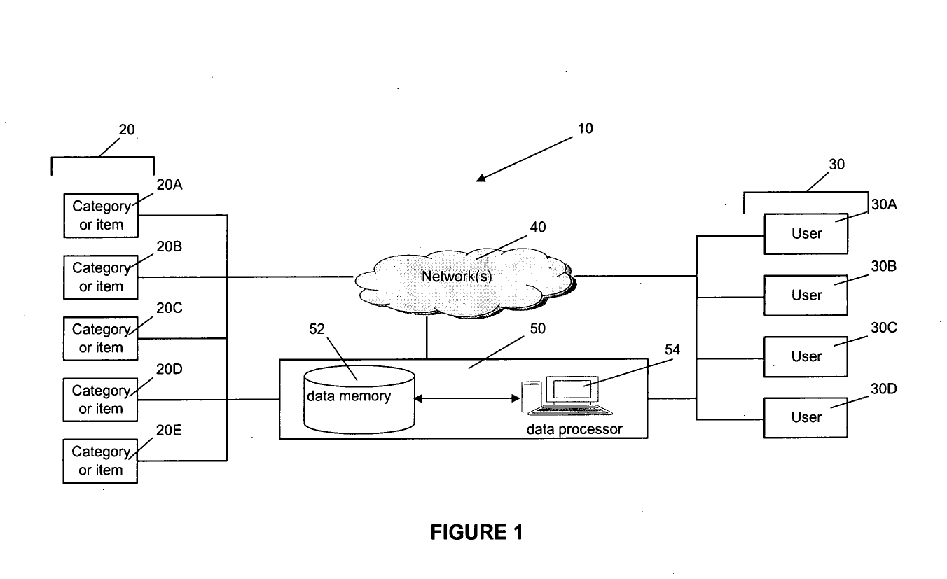

FIG. 1 illustrates a block diagram of the preferred system 10 in which one form of the present invention may be implemented.

The system 10 includes one or more categories generally at 20 for example 20A, 20B, 20C, 20D and 20E. Each category could include for example: movies, books, computer games, restaurants, hotels, vacation packages, qualified trades people, professional consultants, consumer goods. A category could include any service, consumer good or competition which consists of more than one item where the items can be differentiated from each other. In these circumstances, an item must be ranked better than, equal to or inferior to another item. An option is to assign a numerical value identify the margin of difference between different items.

The system also includes one or more users indicated at 30 for example 30A, 30B, 30C and 30D. Each of the users ranks at least three items within one or more categories 20. The user is preferably presented with a list of such categories and items within the categories. The user's preferences could be transmitted to a third party over a network 40.

It is envisaged that network 40 could comprise a local area network or LAN, a wide area network or WAN, an Internet, intranet, wireless access network, telecommunication network, or any combination of the foregoing. It is envisaged that users 30 transmit their preferences from a personal computer, workstation, or hand held device interfaced to the network 30 over the network 40 or by filling in information on a pre-printed card and transmitting these cards to a third party.

The system preferably further comprises a personal computer or workstation 50 operating under the control of appropriate operating and application software having a data memory 52 interfaced to a server or data processor 54, the workstation 50 interfaced to the network 40.

In one form, preferences from users 30 are either input directly into workstation 50 or otherwise transmitted to workstation 50 over network 40. Categories and items within categories 20 are also directly input into workstation 50 or are transmitted to workstation 50 over network 40. The workstation 50 is arranged so that it can prepare a consolidated ranking of all the preferences from users 40.

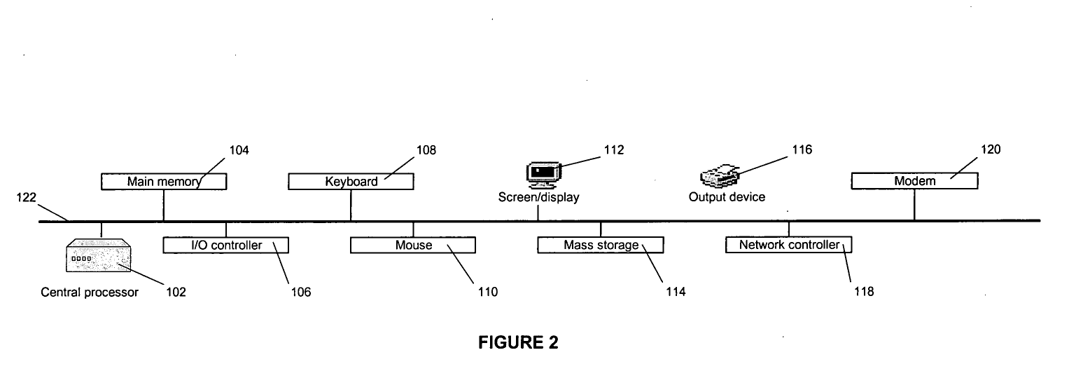

FIG. 2 shows the preferred system architecture of an individual workstation 30 or workstation 50. The computer system 100 typically comprises: a central processor 102; a main memory 104, for example RAM; and an input/output controller 106. The computer system 100 also comprises: peripherals such as a keyboard 108; a pointing device 110, for example a mouse, trackball or touch pad; a display or screen device 112; a mass storage memory 114, for example a hard disk, floppy disc or optical disc; and an output device 116, for example a printer. The system 100 could also include a network interface card or controller 118 and/or modem 120. A system could further comprise wireless data transmission and receiving apparatus. The individual components of the system 100 could communicate through a system bus 122 or alternatively individual components of the system 100 could be distributed over network 40.

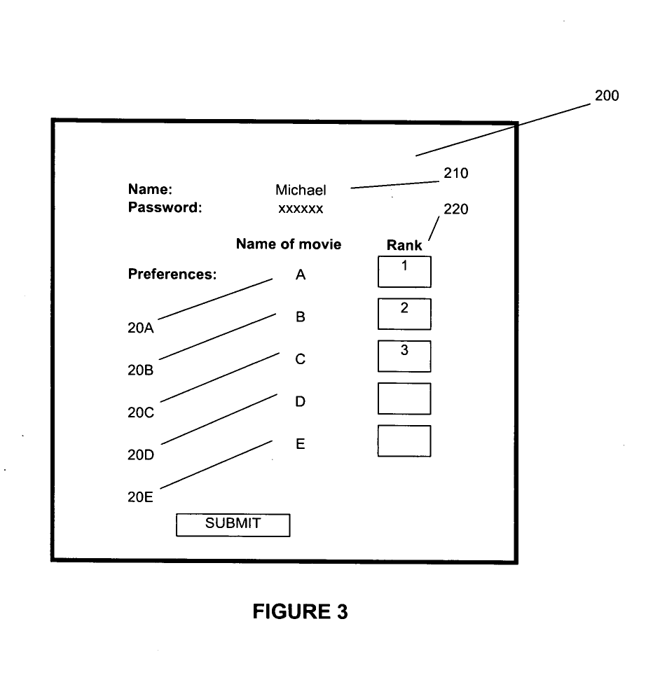

Referring to FIG. 3, each user or potential user has one or more categories and/or items within categories presented to them. As indicated in FIG. 3, each user could be presented with an electronic data entry form over network 40, for example an Internet web page. The user is preferably provided with a screen 200 where one or more categories/items will be presented. In FIG. 3, the category is movies. Different movies 20A, 20B, 20C, 20D and 20E could appear in a vertical column on the interactive screen as shown, displaying information about the movies such as date of production and genre of movie.

The interactive screen 200 could also include an identifier area 210 in which the user inserts the user's name. In this case, the user has inserted the name Michael. Without meaning to exclude the feminine gender, future references to users are in the masculine gender.

The interactive screen 200 could also include a data entry area 220 in which the user can record his preferences for each of the items 20. The preferred area includes a menu that lists the titles of a number of movies. The user indicates the movie which has his first preference by clicking on (or marking) the box associated with that movie. For example, the user in FIG. 3 has indicated the movie “A” as his first preference.

The user then indicates his second and third preferences by marking the boxes associated with other movies. For example, the user in FIG. 3 has indicated the movie “B” as his second preference and the movie “C” as his third preference. At least three preferences must be entered into the interactive screen before the entry will be accepted as complete. The information on interactive screen 200 could be transmitted to and stored on workstation 50.

As an alternative, each user 30 could be provided with a pre-printed form 200 with a data entry area 220 in which the user can enter his preferences for at least three of the items 20. Information concerning preferences could be entered directly into workstation 50 by manual input. These preferences would then be stored on workstation 50.

As another alternative, each user, when entering information on his preferences, could choose to emphasise his preference by assigning various weights of greater than (plus or minus) unity for one or more items. For example, if movie A were assigned a weight of 2 whereas movie B were assigned a weight of one, movie A might be considered twice as good as movie B rather than just being better than movie B.

As another alternative, a user could record personal socioeconomic and demographic information. For example, the user could indicate his sex, his age group, month of birth and which income group he is in. The date on which the information is entered could be recorded automatically if the entry is on-line or notified on the data entry form where data are to be entered by a third party.

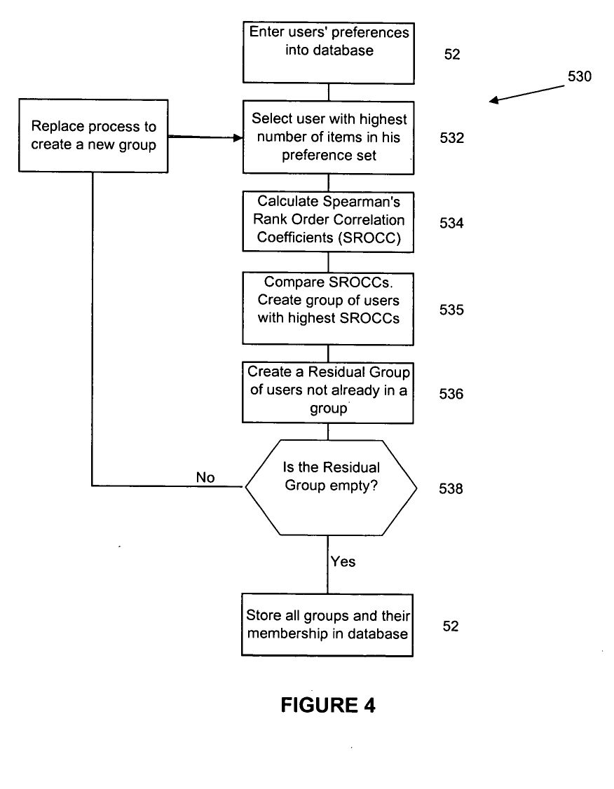

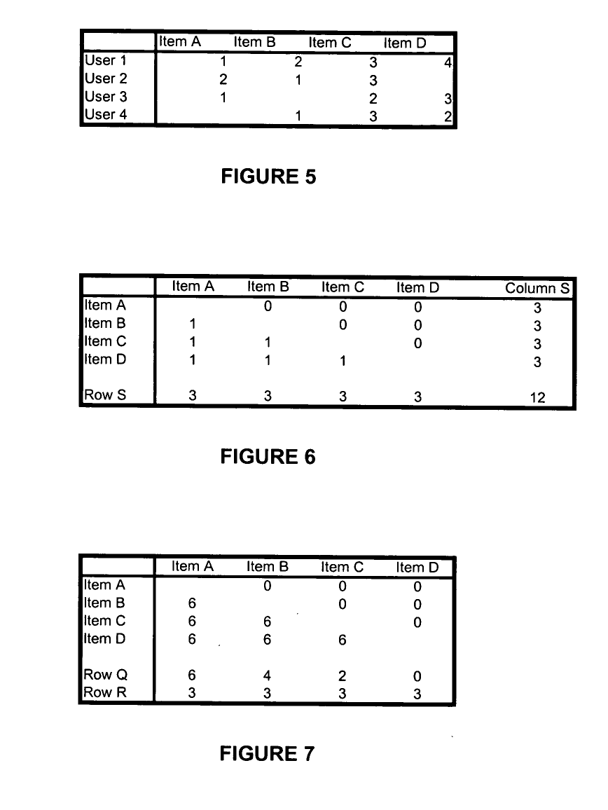

FIG. 4 illustrates a flowchart of a preferred method of grouping the users. The system is indicated generally in FIG. 1. As shown at 52 (FIG. 1 and FIG. 4), users' preferences are entered and stored in the memory of a database. As indicated at 54 (FIG. 1), the preferences are processed by a data processor. An example of the storage of user preferences is given in FIG. 5.

As shown at 532, the user with the most number of units in his preference set is selected as the lead user. The items in another user's preference set are then compared with the items in the lead user's preference set. When an item in one user's preference set matches an item in the other user's preference set, that item is temporarily stored in a list. Any item that is only included in one user's list is ignored. After all items in both lists have been compared with each other, the two condensed lists of preferences will be stored, one for the lead user and the other for the other user. Items in each of these condensed lists will still be in their original order although the rank number of some items may have changed.

These two condensed lists are then compared at 534 using a statistical formula called Spearman's Rank Order Correlation Coefficient (SROCC). The formula is:

$$\frac{1 - 6 Σ {d}^{2}}{( {n}^{3} - n )}$$

Where d is the difference in the rank values for the same item in the two lists (note where one item is ranked equal to another item in the same list, the rank value is the average of the rank value above and the rank value below the items assessed to be equal); and n is the number of items to be compared.

This coefficient is stored. Those experienced in the art will know there are alternative methods of comparing the preference sets of two users. For example, the average value of the absolute differences in the rank numbers of items on the two lists can be used as the means of measuring the correlation.

Correlation coefficients for all users are calculated. Those users with the correlation coefficients exceeding a minimum cut off are assigned to the group created at 535. Users not already assigned to a group are included in a Residual Group at 536.

Provided the Residual Group contains at least three users (537), the process of creating new groups is repeated (532 onwards) by selecting the user in the Residual Group with the most number of units in their preference set as a new lead user. Based on this lead user's preference set, correlations between the lead user and all remaining users are calculated (534). Those users with correlation coefficients exceeding the minimum cut off are assigned to the new group (535). This process continues until every user is either assigned to a group or no new group can be created. Each group must include a minimum number of users, such as three. All users not assigned to a group are combined into an unsorted group. It is possible that during the process of creating groups, some users will be reassigned from one group to another group as a result of a higher correlation with the second group. The reassignment process may result in the membership of some groups falling below the minimum requirement. Users in these groups will then be reassigned to the Residual Group.

Once the first round of creating groups is completed, consolidated preference sets, or quords, are created by the process described below. Once the quords have been calculated, the process of assigning users to groups is repeated ie a user is assigned to that group with which the user has the highest correlation where the correlation is between the user's preference set and the consolidated preference set, that is, the quord, for the group. The quord is calculated using all the items in the users' preference sets not just the items in the lead user's preference set. After the quord has been calculated, it is likely that the preference sets of other users not currently included in the group will be found to be correlated with the quord and thus the size of the group will increase. There is also the possibility that the preference sets of some users in the group will have a lower level of correlation with the quord than they did with the lead user and these users may drop out of the group.

If users are reassigned to new groups and/or new groups are created as a result of this evaluation of best fit, the process of calculating new quords for groups which increase or reduce their membership continues until group membership stabilises (or the process is terminated by an administrator).

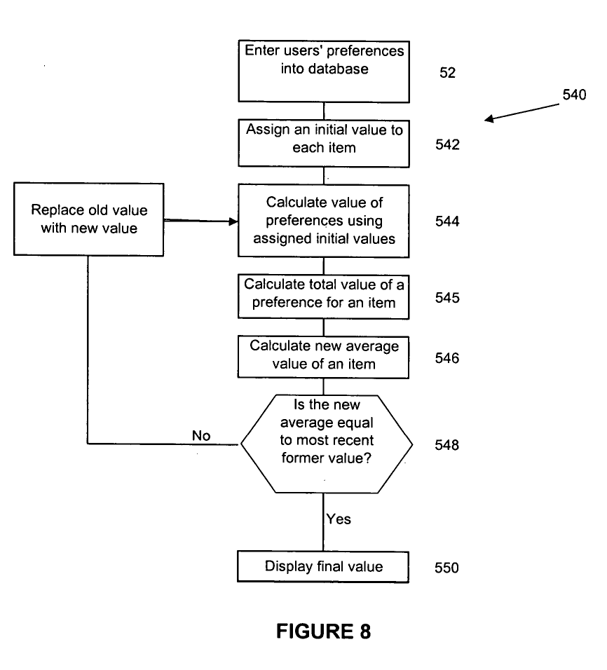

FIG. 8 illustrates a flowchart of the preferred method of calculating a consolidated preference set, or quord, by aggregating the preference sets of all users in a group. The method is indicated generally at in FIG. 1. As shown at 52 (FIG. 1 and FIG. 8), users' preferences are entered and stored in the memory of a database. The preferred method of entering the preferences into the database used to derive the quord is as follows. A matrix (called User Preference Matrix) is created with each item in the preference set being assigned to both a column and a row (see example in FIG. 6). In other words, cell x,y would refer to the relationship between item x and item y. In a two dimensional plane, the items listed on the horizontal axis are defined as superior to the items listed on the vertical axis. The matrix also contains another column (column S) and row (row S) which stores the total number of entries (or votes) in the column or row. When a user ranks item x greater than item y, a value of 1 is added to the value already in the cell x,y and a value of 0 is added to the value already in the cell y,x. When the items are equally ranked, a value of 0.5 is added to each cell. Each time item x is compared to item y (irrespective of whether it is better than, equal to or worse than item y), a value of 1 is added to the value in the cell containing the total number of entries for the column or row, that is, cell S,y and x,S.

As indicated at 54 (FIG. 1), the users' preference sets are processed by a data processor. All the preferences of one user are processed before the preferences of the next user are processed. When a user has ranked four items called A, B, C, D in that order, the following preferences would be entered into the User Preference Matrix: A beats B; A beats C; A beats D; B loses to A; B beats C; B beats D; C loses to A; C loses to B; C beats D; D loses to A; D loses to B; D loses to C (see FIG. 6). The total number of preferences for this user is 12.

The contents of the results database are then examined:
i. If an item has less than a pre-determined number of entries/votes, that item is removed from the User Preference Matrix (UPM) and the UPM recalculated without that item in any user's preference set.
ii. If a user in the UPM has less than three valid votes for items included in the UPM, that user is removed from the UPM. Note: some users may become ineligible only after removal of items under step (i) above. When a user is removed, the UPM is recalculated without that user and step (i) above is repeated.
iii. If an item in the UPM is unanimously preferred by all users, that item is removed from the calculation of the consolidated preference set (quord) and reinserted at the top of the consolidated list after the quord has been calculated (this is called a dominant item or dominance).

To calculate the quord, a new two dimensional matrix (called the Item Preference Matrix) is created with each item having both a column and a row (see FIG. 7). The Item Preference Matrix (ITM) also has two additional rows at the bottom. In the first of these rows (called row Q which is also 542 in FIG. 8), an initial value is assigned to each item. The second of these rows (called row R) is initially assigned these same initial values. The preferred initial value is calculated by summing up the total number of votes cast (the sum of the cells in row S and column S in the User Preference Matrix) dividing by two and then dividing by the number of items in the Item Preference Matrix. Initially, the value in each column in rows Q and R is the same. This means that at the start of the calculation, all items have the same rank.

The data processor then calculates the value in each cell in the Item Preference Matrix by adding together the row Q values of the two items being compared and multiplying the result by the number of preferences favouring the item (that is, the value in the equivalent cell in the User Preference Matrix). For example, suppose the value in the UPM for cell x,y is 5, that is, item x is preferred to item y five times, the value in row Q of column x (of the IPM) is 3 and the value in row Q of column y (of the IPM) is 3, then the value of cell x,y in the IPM is 5 times the sum of 3 and 3 which is 30. This result is temporarily stored at 544.

At 545, the data processor calculates the total value of preferences for item x by adding up the values in column x in the Item Preference Matrix (other than the last two rows) and calculates the average value of item x by dividing this sum by the total number of votes stored in row S column x of the User Preference Matrix. This average value is temporarily stored in cell x,Q of the Item Preference Matrix which is also shown as 546, that is, existing values in the cell are overwritten.

FIG. 7 provides an example where only the preferences of User 1 have been entered into the User Preference Matrix and the Item Preference Matrix.

When the calculations have been completed for all columns of the Item Preference Matrix, the new average value of cell x,Q is compared with to the previous cell value which is stored in x,R (which is shown as 542). The result of this comparison is stored in 548. This comparison is carried out for every item. If there is a difference in value for any of the items, the data processor replaces the existing values in row R (that is, 542) with the new values from row Q (that is, 546). These values are proportionately scaled to ensure the sum of the values is equal to the number of votes/entries divided by two. The process from 544 to 548 is then repeated.

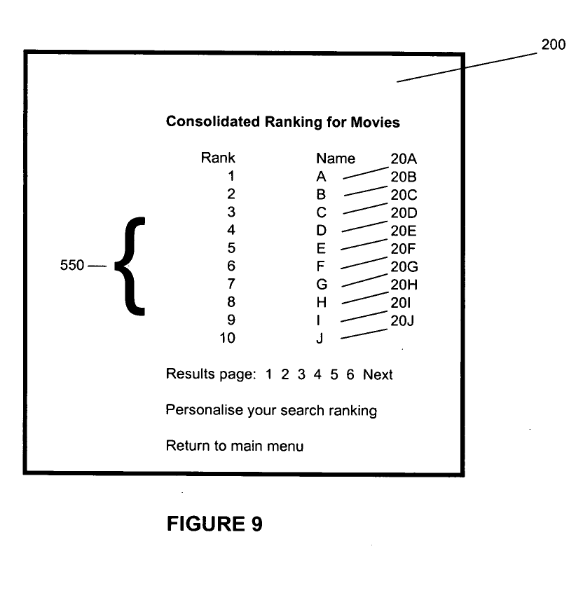

If the result is no change for all the items in the category, the average value is stored at 550 and the quord is displayed as shown in FIG. 9. This result will include any items removed before the calculation of the quord when those items are unanimously preferred by all contributors. This result could be transmitted over the network 40 from workstation 50 to contributors 30. The preferred approach is to terminate the iterations when there is no change in the values in row R. Other approaches are to terminate the process after (i) a set number of iterations; and (ii) the change in values is less than some pre-determined minimum.

Just as an item can be dominant because all users prefer that item over all other items, some items can be reverse dominant, that is, no user prefers that item over any other item. This event requires modification to the calculation of the values in row Q because the values for the reverse dominant items will be driven to zero. In such circumstances, when the smallest value in row Q reaches or falls below 1 after an iteration, that value is fixed at one. If in the next iteration, the next smallest value falls below 1, it is assigned the value it had in the previous iteration when it exceeded 1. If the next lowest value falls below the second lowest value (as determined in the previous sentence), it reverts to the value it had in the previous iteration. This process is repeated until there is no change in the values of row Q compared to row R (or the process is terminated by the administrator).

This consolidated preference set is defined by more contributors preferring item i to item j (for any i and any j) when the relative strength of the consolidated preferences for all the other items in the category (that is, the weights calculated in row R of the Item Preference Matrix) is taken into account in the valuation. The discussion in the Background section of this document implied that each user's preference set would need to be identical in order to calculate a consolidated preference set. The foregoing calculations do not require such an assumption. However, this document does not claim that the resulting consolidated preference set represents a preferred set in the terminology of social choice theory. The purpose of the calculations is to group together like-minded users. All that is claimed is that this process shows there is no necessity for all users to be identically minded in order to create a large group of users who have similar ordinal preferences.

The difference between the quord approach and the creation of similarity neighbourhood groups is that the quord groups do not necessarily have a lead user with whom all group members must have some overlapping preferences.

One preferred approach to calculating the quord would be to create a number of quords by using different sets of random numbers to set the initial rank value of an item. For each quord, each user's correlation coefficient would be calculated. The preferred quord is the one with the lowest sum of squares of the deviations of each user's correlation coefficient from unity.

Another preferred approach is to use some pre-determined initial values, such as those generated from a quord calculated for some other purpose, such as when the membership composition was slightly different or where the number of items included was slightly different.

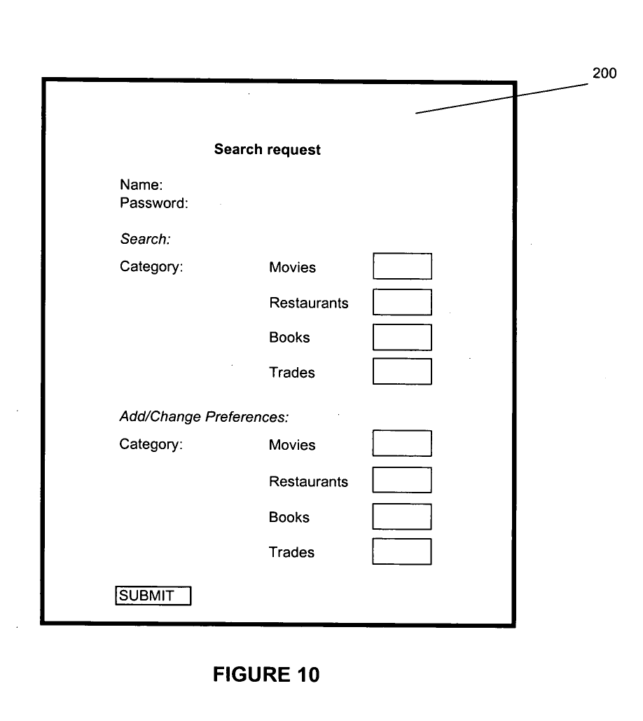

FIG. 10 illustrates the system for requesting a search. Referring to FIG. 10, each contributor could be provided with a Login screen that uniquely identifies each contributor. Once the contributor's name and password is entered, the contributor may then request a search or an opportunity to add/change items in their existing preference set. If the login is not accepted, the reason for the failure is presented on the screen and the contributor given another opportunity to enter the correct details.

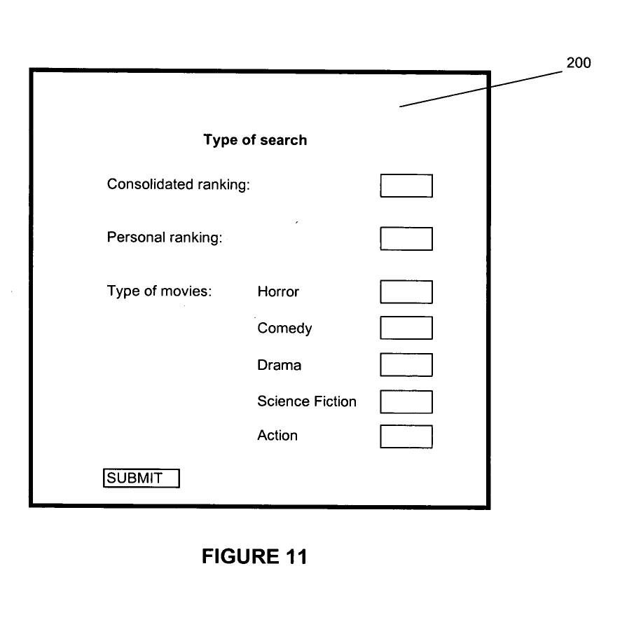

When the login is accepted, an interactive screen relating to the request is presented. Referring to FIG. 11, this is the screen that will be presented to enable a user to enter a search request. For example, the user could request the quord for all items (which is at 550); and/or the quord for a subset of items that the user has defined based on his mood or desired ambiance. The user enters the appropriate details and clicks on the SUBMIT button.

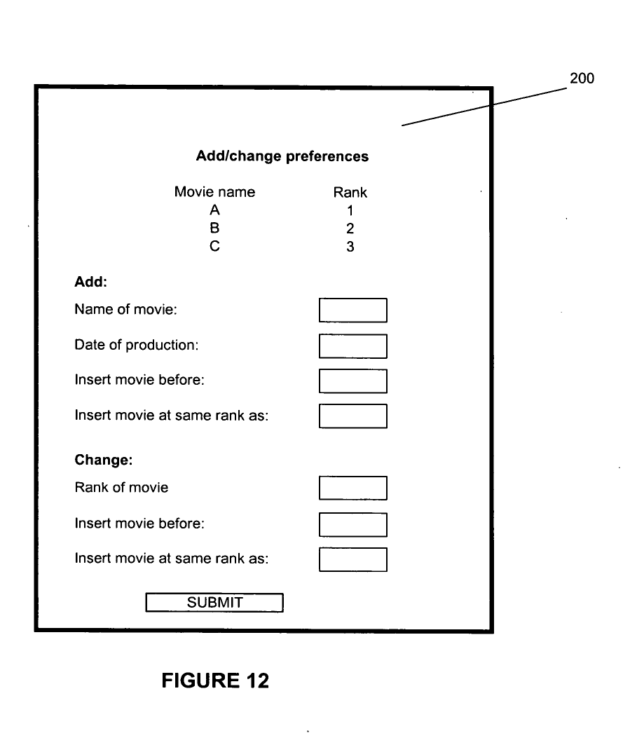

Referring to FIG. 12, this is the interactive screen that will be presented to enable a user to modify their preference set. The user will be able to reorder their preferences as well as add or delete an item. For each action, the screen will be refreshed with the new information added. One option is for both the old preferences and the new preferences to be stored in the database. These preferences may be allocated weights which relate to the time at which the preference is recorded in the database. Once all the information has been added, the user will be given the opportunity to logout or return to a previous screen.

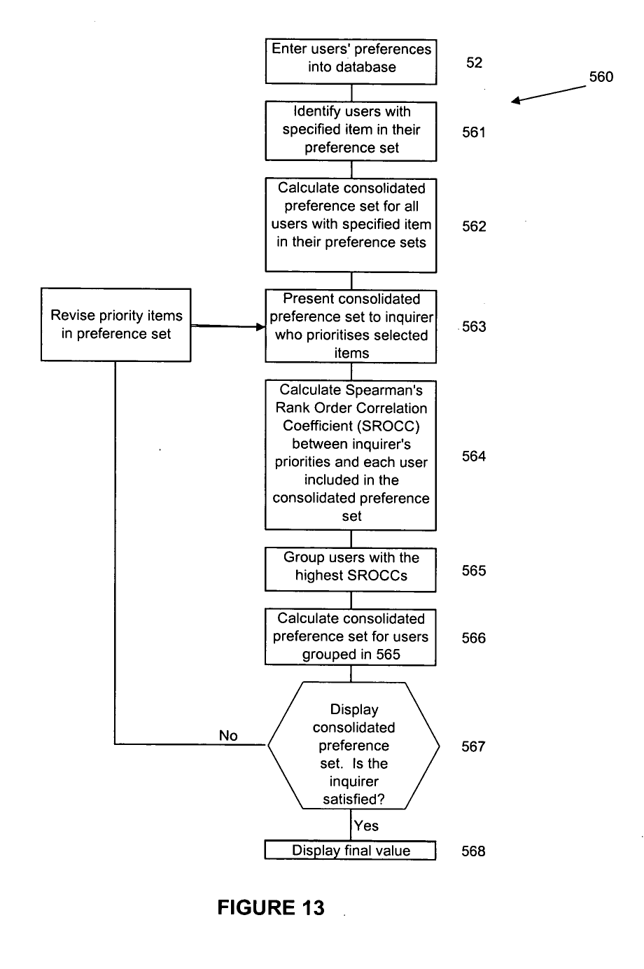

FIG. 13 illustrates the flow chart for generating a response to a specific inquiry based on information already provided by other users. This method is indicated generally at 560. As shown at 52 (FIG. 1 and FIG. 13), users' preferences and personal characteristics are entered and stored in the memory of a database. As indicated at 54 (FIG. 1), the preferences are processed by a data processor.

As shown at 561, all users whose preference sets contain the item requested in the specific search are abstracted from the database 52 by the data processor 54. These preference sets are consolidated into a quord at 562 which is presented to the inquirer at 563. The inquirer is asked to rank a number of items in the list. Using the ranking provided by the inquirer, Spearman's Rank Order Correlation Coefficients are calculated at 564 for each user in the quord. Those users with high correlation coefficients are combined into a new group at 565 and a new quord calculated at 566.

The inquirer is presented at 567 with the results of the new quord and asked whether their preference set needs to be refined further.

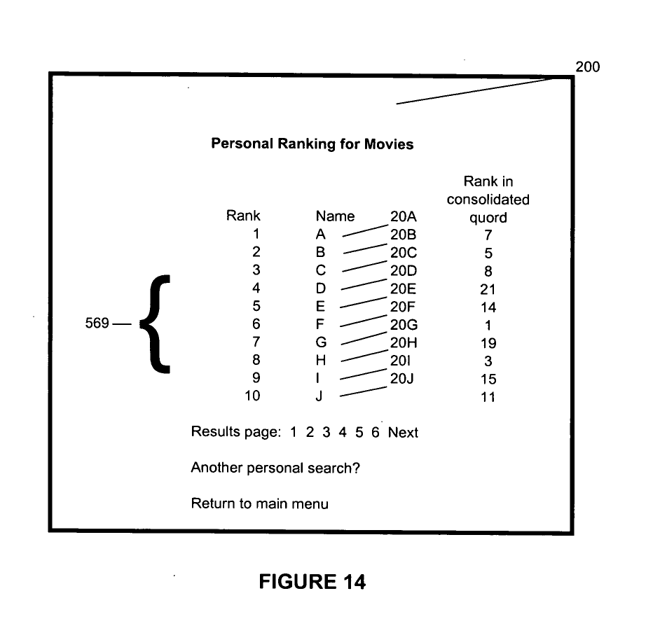

After all refinements to the inquirer's preference have been incorporated, the final quord result in 568 could be displayed as shown in FIG. 14. This result could be transmitted over the network 40 from workstation 50 to contributors 30. In this presentation, there is no indication as to the level of satisfaction that a user may get from consumption of the product or service. The items are ranked relative to items known to the user and the user makes his own judgement about his likely utility or satisfaction. Thus only ordinal ranking is needed to help a user choose.

Referring to FIG. 14, the second column could show the first ten items in the personal quord. The third column could indicate where the same ten items are ranked in the quord containing the preference sets of all users.

The invention provides a simple and effective way of ranking a number of items based on the personal ordinal preferences of users. The items are individual items within categories which could include a wide range of services and consumer goods.

Another form of the invention creates groups through identifying users with similar preferences across categories as well as associated items within the same category.

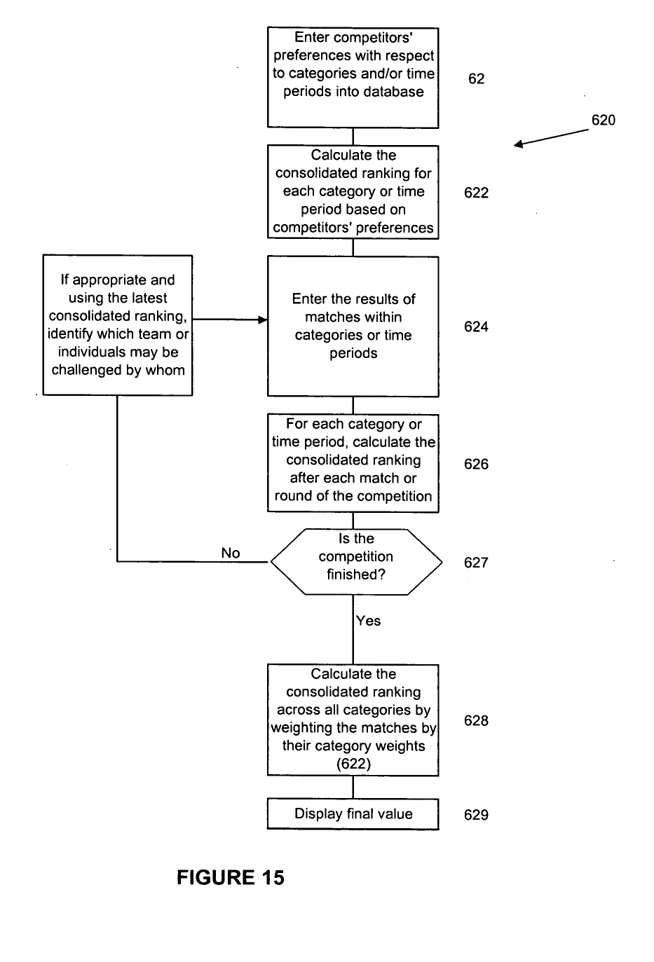

Another form of the invention compares items across categories and/or time. FIG. 15 illustrates the flowchart for ranking the items. One example is a competition where competitors can challenge each other. There may be several different types of games or categories. The objectives are to determine the best player/team in each game and across all games. Competitors enter their ordinal assessment of relative skills required in the different games (62). The quord associated with these preferences is calculated (622) using the processes described in FIG. 8. The results of individual matches are entered into the database in the form of the winning team being preferred to the losing team (624). Within each category, the quord is calculated after each match or competition round to determine the order of ranking for all competitors (626). This quord may also be used to determine who is eligible to compete with whom in the next series of matches (624).

At the end of the competition (627), the quord across all categories is calculated using the weights calculated in 622 to help determine the value of each match. The final results are presented to the competitors (629).

### EXAMPLES OF THE USES OF THE INVENTION

The invention as described so far demonstrates how people can be helped to find an object of interest. Some other uses of the invention, such as ranking competitors, have also been discussed. These examples demonstrate the invention is not limited to a particular application. Through slight modifications to the processes of identifying preferences and sorting, the invention can be shown to have a wide range of applications. For example, the invention can be modified to assist in a joint search such as where one person is looking for another person who has similar interests. This application will be described as an example of how to extend the above description which relates to a single person search.

### Example 1

### Matching People with Similar Interests

Participants in the arrangement described in FIG. 1 will enter their preferences into the system. These preferences could be in the form of several categories with preferences indicated for individual items within a category. For example, one category could be hobbies and items within the category being various types of sports and recreational activities. Participants will enter data consisting of at least two types. The first type of data will be a description of themselves. The second type will describe what they are looking for. Categories in the first type will not be ranked by the participant. Categories in the second type may be ranked in terms of essential and desirable criteria.

Without any priority assigned to the various criteria and with a large number of participants, the number of possible combinations of people is potentially very large. Some filter is required to prioritise the various possible matches. One possible filter is aggregating people into groups with generally similar but not identical criteria/items. Initially, first priority would be given to the most popular item recorded by the participants in a group. Participants will be preliminarily included in the group when they have included the identified item in their list or when their personal quord correlation is above a minimum value. (Where there are a number of items within a category, a quord would be calculated to rank the items Within the category. The quord would be based on the preferences of all participants included in the group.) Then the next most popular item/category would be used to reduce the number on the group etc until either all categories are used up or the group reaches a ‘reasonable’ size.

When the group size approaches a ‘reasonable’ size, the decision to include a participant in a particular group will depend on how similar their preferences are to the group preferences where the value of their personal correlation with the quord in each category is the measure of correspondence. A preferred method of assessing similarity is the average correlation recorded across all categories.

Once one group has been determined, a second group will be created from those participants not included in the first group. The same winnowing process will be used. New groups will be continuously created until all participants are included in a group.

As increasing use is made of the system, a pattern is likely to emerge indicating how participants rank the importance of the categories in different types of searches. Participants can then be regrouped using these revealed priorities.

After participants have been organised into groups, the searcher's preference set will be correlated with the groups created from type 1 data to determine which group is most highly correlated with the searcher's preference set. The type 2 preference sets of the participants within the selected group will then be correlated against the searcher's type 1 categories using the category priorities of the type 1 group containing the searcher. Participants will be ranked by their correlations and, initially if the correlation is above a minimum, contact information will be provided to the searcher.

Participants will also be invited to rank other participants with whom they have come into contact through the system. This ranking will just rank the participants. It will not provide any reason for the ranking, although it is likely to reflect the degree of compatibility that one participant feels with another participant. When sufficient data have been collected on the ranking of individual participants, participants will be assigned to a group based on the confidentially revealed preferences for other participants. This ranking system will then be used instead of correlation coefficients in the last stage of the selection process in identifying the participants most likely to meet the requirements of the searcher. In other words, once sufficient participants have been identified through the group selection process described in the preceding paragraphs, wherever possible, person preference profiles will be used to rank the selected participants. The searcher will need to be ranked highly on their prospective partner's preference profile and the prospective partner will need to be ranked highly on the searcher's preference profile.

The above description describes an example of how the invention is both the ‘engine’ behind the system and how the system architecture may evolve as a result of the invention. The invention has the potential to create a range of new system architectures that may only be completely specified once the invention is operational.

### Example 2

### Assisting Searching on the World Wide Web

Another example of how the system architecture of the invention may change as a result of increasing use of the invention is in assisting users in prioritising the results of an internet search using a search engine such as Google. Initially the invention may be used dynamically by presenting a selection of web sites to an inquirer in response to a request. The selection of web sites could be based on feedback from other users who have previously made the same request. The inquirer will provide their own feedback on some of the selected sites thus building up a preference profile that will enable the selection of sites to be refined according to their own preferences. Increased use of this search facility could result in Google changing its basis for ranking web sites, that is, feedback from the usefulness of searches. With such a development, the parameters used by Google to rank the results of a search may change thus changing the system architecture when using this invention to ranking search results eg Google may request/utilise an inquirer's preference profile before the search.

People could also rank websites associated with different search words. These ranked lists of websites can be combined through use of this invention with several different groups being formed reflecting the different personal preferences of members in the groups. The appropriate consolidated list would be displayed in response previously revealed preferences of a searcher thus reducing time taken to search.

### Example 3

### Using Socioeconomic and Demographic Information

Another form of the invention is to compare personal socioeconomic and demographic information and identify groups of users who have characteristics highly correlated with the inquirer. The aggregate preferences (quord) of these compatible groups for a category of interest to an inquirer could be calculated and then displayed to the inquirer.

### Example 4

### Horse Racing

Another form of the invention is in connection with predicting future events. For example, the results of horse races could be analysed in the same way as people's preferences with different race conditions such as the weather and length of the race being equivalent to different sets of preferences. Correlated results of horse races could be aggregated by the quord methodology and predictions made about the order in which horses will finish in other races.

Having described preferred embodiments of the invention, it will now become apparent to one of skill in the art that other embodiments incorporating the concepts may be used. These embodiments, therefore, should not be limited to disclosed embodiments but rather should be limited only by the spirit and scope of the following claims.

1. An interactive method of creating a consolidated ranking in response to a request for a prediction from a requestor where the consolidated ranking predicts how the requestor would rank items, which may be unfamiliar to the requester, using reports that have been provided by a plurality of users containing the order that items are ranked, said items selected from one or more of the categories of products, services, performers, competitors, events and the like; where the method includes the sequential steps of:
(a) presenting to said users a list containing three or more items, said users may include said requestor;
(b) obtaining from said users, reports ranking three or more of the items presented in step (a);
(c) creating groups of said users by choosing some of the users to be lead users; calculating correlation between the order that items are ranked in the report of a lead user and the order that the same items are ranked in the report of another user when the reports of both users contain at least three of the same items; and grouping together all users whose reports have calculated correlation with the lead user in excess of a predefined value;
(d) creating separately for each group formed in step (c), a consolidated ranking of all items included in the reports of at least three users in the group by an iterative process that orders items on the basis of the number of times that users in the group rank an item higher than another item when the number of times such assessment is made is weighted by the sum of weights assigned to the two items where those weights were calculated in the previous iteration and where the items' weights for the first iteration are predetermined;
(e) calculating correlation between the order in which items are ranked in each user's report and the consolidated ranking of every group derived in step (d) and then assigning said user to the group with which the said user is most highly correlated;
(f) repeating step (d) using the new groups formed in step (e);
(g) repeating steps (e) and (f) until there is no change in the membership of any group and no change in the list of items in each group's consolidated ranking;
wherein by this process a consolidated ranking for a group, containing predictions based on a request, can be created even though the items in the report of the requester may not overlap with any of the items in the reports of some of the other said users in the same group.

2. An interactive method of creating a consolidated ranking as claimed in claim 1 wherein step (c) comprises the sub-steps of:
(i) initially choosing as a lead user, that user who has recorded the most items in his/her report;
(ii) identifying a group of other users who have at least three items in their reports in common with the items in the report of the lead user;
(iii) calculating the correlation between the order that items are ranked in the lead user's report and the order the same items are ranked in the report of another user when there are at least three items in common in their reports;
(iv) creating a group of other users for whom the calculated correlation between items in their reports and items in the report of the said lead user exceeds a predefined value; and
(v) repeating sub-steps (i) through (iv) for all users not included in the previous sub-step (iv) until no new group consisting of a number of users in excess of a predefined value can be formed in sub-step (iv).

3. An interactive method of creating a consolidated ranking as claimed in claim 2 wherein step (d) of claim 1 comprises an iterative process involving the sub-steps of:
(i) checking that each user has ranked in his/her report more than a predefined number of items that are also included in the list of items in a group's consolidated ranking and where such check fails that user is excluded from the group;
(ii) checking that each item included in a group's consolidated ranking is included in more than a predefined number of reports of users who are members of the group and where such check fails that item is excluded from the group's consolidated ranking;
(iii) repeating sub-steps (i) and (ii) until no more users or items are excluded;
(iv) assigning predefined initial weights to all the items in a group's consolidated ranking;
(v) multiplying the number of times a particular item is preferred to another item (separately for each other item) by the sum of the weights assigned to the particular item and each other item as described in sub-step (iv);
(vi) summing the values calculated in sub-step (v) for each of the other items; dividing this value by the number of times users have ranked the particular item; and assigning the result of this calculation to be the new weight associated with the particular item;
(vii) sequentially for every item repeating sub-step (v) using the initial values assigned in sub-step (iv);
(viii) sequentially for every item repeating sub-step (vi) except that the values to be added up are those calculated in sub-set (vii) not sub-step (v) and the calculated value is assigned to the item with which all comparisons are being made where the latter item is not necessarily the original particular item;
(ix) repeating sub-steps (vii) and (viii) except that the initial values assigned in sub-set (iv) are replaced by values calculated in sub-step (viii); and until the change in weight value of each other item after a repetition is less than a predefined value.

4. An interactive method of creating a consolidated ranking as claimed in claim 3 further including the steps of:
(h) transmitting users' reports to a central data storage facility;
(i) storing the said users' reports in a data memory and retrieving the ranking of items in those reports for use in generating a consolidated ranking for the group to which the user is assigned;
(j) storing both the correlation of users' reports and an identifier of the group to which the user is assigned in a data memory so that the consolidated ranking of the user's group can be retrieved and presented to the user; and
(k) transmitting a user's request for an additional consolidated ranking to a central processing workstation;
whereby a user can submit a request; the request can be processed; the response to the request presented back to the said user; and the said user can submit a follow up request to the first request.

5. An interactive method of creating a consolidated ranking as claimed in claim 4 further including the steps of:
(l) responding to a user's request to create a new consolidated ranking by changing the items to be included in the list presented to users;
(m) responding to a user's request to create a new consolidated ranking by selecting which users' reports can be included in a group; and
(n) responding to a user's request to create a new consolidated ranking by assigning predefined variable weights to selected items included in the reports of users.

6. An interactive method of creating a consolidated ranking as claimed in claim 5 further wherein: the weights to be associated with items included in users' reports are predefined; the weights to be associated with all the items in selected users' reports are predefined; the difference in correlation to be used in selecting which users are to be included in a group is predefined; and the maximum number of iterations which can be performed before an iteration process is terminated, is predefined.

7. A interactive method of creating a consolidated ranking as claimed in claim 6 further including the steps of:
(o) presenting to a user the consolidated ranking of the group to which the said user has been assigned; and
(p) responding to a user's request to present to other users selected information such as the said user's reports which are stored in data memory.

8. A system for creating a consolidated ranking which predicts how a user would rank items as a result of creating a group containing the reports of a plurality of users even when the items in the report of the user who has requested the prediction may not overlap with any of the items in the reports of some of the other said users in the group; wherein the system includes:
(a) a display arranged to present to said users a list containing three or more items as specified in claim 1(a);
(b) a data entry component arranged to obtain from said users reports ranking three or more of the items presented in step 1(a) as specified in claim 1(b);
(c) a mechanism arranged to compare the correlation of the said user' reports as specified in claim 1(c);
(d) a mechanism arranged to compare the number of items in a said user's report with a predefined number as specified in claim 3 sub-step (i);
(e) a mechanism arranged to compare the number of said users including an item in his/her report with a predefined number as specified in claim 3 sub-step (ii); and
(f) a mechanism arranged to present to a said user a consolidated ranking as specified in claim 7.

9. A system for creating a consolidated ranking as claimed in claim 8 wherein the data entry component arranged to obtain a report from a said user includes a workstation interfaced to a data memory through a network.

10. A system for creating a consolidated ranking as claimed in claim 9 wherein the mechanism arranged to compare the number of items in a said user's report is further arranged to reduce to zero the weight for an item when the number of items in the said user's report is less than a predefined number.

11. A system for creating a consolidated ranking as claimed in claim 10 wherein the mechanism arranged to compare the number of users including an item in his/her report is further arranged to reduce to zero the weight for a said user when the number of users including a said item in his/her report is less than a predefined number.

12. A system for creating a consolidated ranking as claimed in claim 11 wherein the mechanism arranged to compare the number of users assigned to a group to create a consolidated ranking is further arranged to include users who have correlations with the consolidated ranking of a group that are below the predefined value for his/her inclusion in the group.

13. A system for creating a consolidated ranking as claimed in claim 12 wherein the mechanism arranged to transmit the consolidated ranking to a said user includes a workstation interfaced to a data memory through a network.

14. A data processing system readable medium having code embodied therein, the code including instructions executable by a data processing system for performing the steps of claim 1.

15. The data processing system readable medium in claim 14 further including code for performing the steps of claim 3 and wherein sub-step (i) in claim 3 which compares the number of items in a user's report reduces to zero the weight for an item when the number of items in the user's report is less than a predefined number.

16. The data processing system readable medium in claim 15 wherein sub-step (ii) of claim 3 which compares the number of users including an item in his/her report reduces to zero the weight for an item when the number of users including a said item in his/her report is less than a predefined number.

17. The data processing system readable medium in claim 16 wherein sub-step (ii) of claim 2 which compares the number of users assigned to a group to create a consolidated ranking includes users who have correlations with the consolidated ranking of a group that are below the predefined value for his/her inclusion in the group.
